(19) United States
(12) Patent Application Publication
(10) Pub. No.: US 2008/0173659 A1
(43) Pub. Date: Jul. 24, 2008

(54) Magnetic label stock material

(75) Inventor: Keith Medley, Marietta, OH (US)

Correspondence Address: Jerome J. Norris, Suite 305, 1901 Pennsylvania Avenue, N.W., Washington, DC, 20006, US

(73) Assignee: Keith Medley

(21) Appl. No.: 11/655,094

(22) Filed: Jan. 19, 2007

Related U.S. Application Data
(63) Continuation-in-part of application No. 10/579,786.

(51) Int. Cl. B65G 47/04; B32B 33/00; B32B 37/12

(52) U.S. Cl. 221/1; 428/41.8; 156/60

(57) ABSTRACT

A magnetic label stock tape that is less prone to damage in handling in labeling machines comprising:

a) a translucent tape having a longitudinal direction and a traverse direction and a dimension in the transverse direction, and at least one major release surface; and

b) a plurality of magnetic labels, each of the magnetic labels having at least one major surface at least partially covered with a pressure sensitive adhesive, the magnetic labels being fixed on the release surface by means of the pressure-sensitive adhesive;

wherein the labels are spaced in the longitudinal direction by a distance sufficient to permit transmission of an optical signal through the tape between the magnetic label, and wherein at least some of the magnetic labels have a dimension in the transverse direction substantially equal to or extending beyond the transverse dimension of the translucent tape.

This application is a continuation-in-part of application Ser. No. 10/579,786 filed Feb. 22, 2002 as PCT/US03/04507.

### BACKGROUND OF THE INVENTION

This invention relates to magnetic labels and more particularly to a stock material for applying magnetic labels to a substrate.

1. Field of the Invention

2. The Prior Art

Thin flexible magnetic labels, flexible magnets for supporting papers and the like, and said small magnetic signs are commonly distributed in commerce as attachments to substrates such as paper, cardboard and the like. The thin flexible magnetic articles are typically applied to the substrate with conventional label application machines and adhered to the substrate by an adhesive, e.g., a pressure-sensitive adhesive.

The thin flexible magnetic articles are supplied to the applicator machine in the form of a thin,-flexible tape with the magnets arranged sequentially thereon. The magnets are adhered to the tape by a pressure-sensitive adhesive coating on the side facing the tape. The tape, which may be paper, or a synthetic resin web, such as polyethylene, polypropylene or polyester, has a release surface, i.e., a surface that allows the magnet to be easily removed therefrom while the pressure-sensitive adhesive remains on the back of the magnet. If the tape material does not naturally have a release surface, it may be treated with the material, e.g., a silicone, to give it release properties. Such release tapes are conventional in the art.

Typically, the labels or magnets on such supply tapes do not extend to the extreme edges of the tape. For paper labels, which are relatively thin, perhaps 0.003-0.005 inches thick, a tightly coiled roll of stock tape may be formed and handled.

However, magnets applied by the conventional label technique are thicker in that they typically range from about 0.0006 to about 0.060 inches in thickness. With such thicker materials, the edges of the tape will extend beyond the edges of the magnets as they are relatively widely spaced when the tape is coiled for distribution and handling. Consequently, the thin paper edges of the rolls that are more widely spaced and extend beyond the edges of the magnets are often bent, crushed, distorted, or even torn in the course of the handling necessary to distribute the rolls and mount them on the labeling machine. Such distorted edges present problems with the smooth operation of the labeling machine because they may not interact properly with the guides and/or may get caught in the labeling machine.

U.S. Pat. No. 3,970,506 disclose apparatus for applying one label of a plurality of labels each carried in a successive position on a tape to a flat article moving in one direction. There is no reference to or mention of; or a showing that the magnetic material extends beyond the edges of the magnet so as to pose a risk of being bent, crushed or distorted when handled by a labeling machine.

A series of labels on backing with light source and photo sensitive switch operative thereupon is disclosed in the U.S. Pat. No. 5,232,540. A gap separates each adjacent pair of labels on the backing that creates a differential in light transmissibility that is detected by photosensitive apparatus that assist in transfer of labels with a pressure sensitive adhesive from a release backing.

Accordingly, a need has continued to exist for a stock material for application of magnetic labels and the like that does not suffer from the deficiencies of the already known materials.

### SUMMARY OF THE INVENTION

Accordingly, it is an object of the invention to provide a magnetic label stock tape wherein the edges of the tape are less prone to damage in handling.

A further object of the invention is to provide a magnetic label stock tape wherein the edges of the tape are less prone to damage in handling as a result of extending the magnetic labels substantially to the edges of the tape.

Further objects of the invention will become apparent from the brief description of the drawings and detailed description of the preferred embodiment of the invention.

### BRIEF DESCRIPTION OF THE DRAWINGS

FIG. 1 is a plan view of a section of the magnetic label stock tape of the invention.

FIG. 2 is a side elevational view of the magnetic label stock tape of the invention.

FIG. 3 is a view in perspective of a coil of the magnetic label stock tape of the invention.

### DETAILED DESCRIPTION OF PREFERRED EMBODIMENT OF THE INVENTION

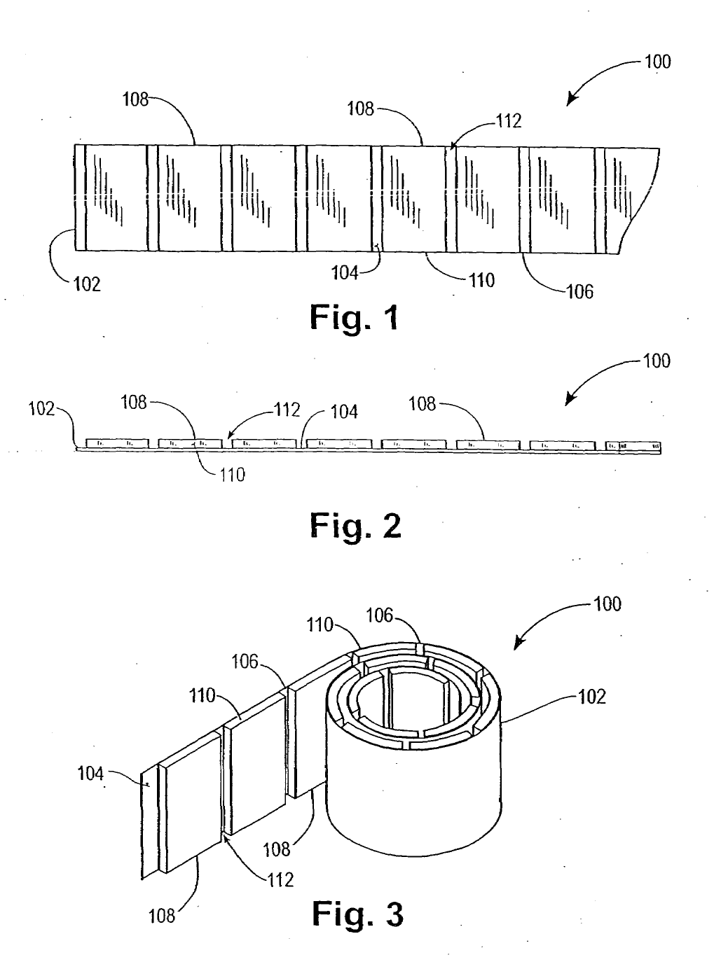

The magnetic label stock tape 100 of the invention will be described with reference to the figures and drawings. As may be seen from FIG. 1, the stock tape 100 includes a flexible translucent substrate 102, which has a release surface at least on the upper surface 104 on which the magnetic labels 108 are carried. The tape may be made from a synthetic resin, e.g., polyethylene, polypropylene, polyester, or the like. The tape may also be made of a non-woven web, such as paper, having a release coating, e.g., a silicon coating, on its upper surface 104, as shown in FIG. 2 and known to those skilled in the art. It is not excluded that the tape may be made of a woven material, e.g., cloth or the like, having a release coating on its upper surface 104, if necessary. A preferred material for the flexible translucent substrate 102 is a polyester, e.g., poly (ethylene terepthalate), and a more preferred embodiment is mineral filled polyester.

The magnetic labels 108 may be any conventional flexible magnetic label. Such labels are made from suspensions of magnetizable material., e.g., and appropriate ferrite, dispersed in a flexible synthetic resin or rubber binder, and subsequently magnetized. Such flexible magnetic labels are well-known and widely used. Typically the magnetic labels 108 range from about 0.006 inches to about 0.060 inches in thickness.

The magnetic labels 108 are fixed to the upper surface 104 of the tape with a thin layer of a pressure-sensitive adhesive (not shown) on the back of each label 108. The magnetic labels 108 are spaced along the longitudinal direction of the tape 102 with small intervals 112 between them. The tape 102 itself is translucent. Accordingly, the conventional optical sensing devices that control the movement of the tape 102 through the labeling machine can operate in their normal fashion.

The magnetic labels 108 have a dimension in the lateral direction of the tape 102, i.e., at right angles to the longitudinal direction of the tape 102, that is generally equal to the width of the tape in the lateral direction. Accordingly, the labels are sized to extend substantially to the lateral edges 106 of the tape 102. Consequently, the relatively thin and delicate edges 106 of the tape 102 are supported along most of their length by the lateral edges 110 of the magnetic labels 108. This tends to prevent crushing, distortion, or tearing of the tape substrate 102 when a coil of the stock material 100 is distributed and handled. This arrangement of the magnetic labels also allows the edge guides in the label application machine to bear for the most part on the edge 110 of the magnetic label and the portion of the edge 106 of the tape 102 reinforced by contact with the magnetic label. Accordingly, the tape 102 tends to run more smoothly through the label application machine.

When the stock material 100 is coiled for shipping, distribution, etc., as shown in FIG. 3, the lateral edges 1 10 of the magnetic labels 108 substantially coincide with the lateral edges 106 of the tape 102. Consequently the edges 106 of the tape 102 are largely protected from damage in handling and use.

The propensity for damaging upon handling of the conventional magnetic label stock materials, have now been alleviated by the innovations of the invention, which comprises:

a flexible translucent release tape having magnetic labels adhered thereto with a pressure sensitive adhesive,

the magnetic labels being spaced along said tape with light-transmissive gaps therebetween, and

the magnetic labels extending substantially to the edges of said tape.

The invention having now been fully described, it should be understood that it may be embodied in other specific forms or variations without departing from its spirit or essential characteristics. Accordingly, the embodiments described above are to be considered in all respects as illustrative and not restrictive, the scope of the invention being indicated by the appended claims rather than the foregoing description, and all changes which come within the meaning and range of equivalence of the claims are intended to be embraced therein.

1. A magnetic label stock tape that is less prone to damage in handling in labeling machines comprising:
a) a translucent tape having a longitudinal direction and a traverse direction and a dimension in said transverse direction, and at least one major release surface; and
b) a plurality of magnetic labels, each of said magnetic labels having at least one major surface at least partially covered with a pressure sensitive adhesive, said magnetic labels being fixed on said release surface by means of said pressure-sensitive adhesive;
wherein said labels are spaced in said longitudinal direction by a distance sufficient to permit transmission of an optical signal through said tape between said magnetic label, and wherein at least some of said magnetic labels have a dimension in said transverse direction substantially equal to or extending beyond said transverse dimension of said translucent tape.

2. The magnetic label stock tape of claim 1 wherein said translucent tape is a synthetic resin.

3. The magnetic label stock tape of claim 2 wherein said synthetic resin is a polyester.

4. The magnetic label stock of claim 3 wherein said polyester is poly (ethylene terephthalate).

5. The magnetic label stock of claim 2 wherein said synthetic resin is selected from the group consisting of polyethylene and polypropylene.

6. The magnetic label stock of claim 3 wherein said polyester is a mineral filled polyester.

7. In a method of mounting a supply tape of a magnetic label stock in which magnets are adhesively attached to the substrates, the improvement of preventing thin substrate edges from becoming bent, crushed, distorted and torn, comprising supplying to a labeling machine:
a) a translucent tape having a longitudinal direction and a traverse direction and a dimension in said transverse direction, and at least one major release surface; and
b) a plurality of magnetic labels, each of said magnetic labels having at least one major surface at least partially covered with a pressure sensitive adhesive, said magnetic labels being fixed on said release surface by means of said pressure-sensitive adhesive;
wherein said labels are spaced in said longitudinal direction by a distance sufficient to permit transmission of an optical signal through said tape between said magnetic label, and wherein at least some of said magnetic labels have a dimension in said transverse direction substantially equal to or extending beyond said transverse dimension of said translucent tape.

8. In a method of distributing a supply tape of a magnetic label stock in which magnets are adhesively attached to the substrates, the improvement of preventing thin substrate edges from becoming bent, crushed, distorted and torn, comprising distributing from a labeling machine:
a) a translucent tape having a longitudinal direction and a traverse direction and a dimension in said transverse direction, and at least one major release surface; and
b) a plurality of magnetic labels, each of said magnetic labels having at least one major surface at least partially covered with a pressure sensitive adhesive, said magnetic labels being fixed on said release surface by means of said pressure-sensitive adhesive;
wherein said labels are spaced in said longitudinal direction by a distance sufficient to permit transmission of an optical signal through said tape between said magnetic label, and wherein at least some of said magnetic labels have a dimension in said transverse direction substantially equal to or extending beyond said transverse dimension of said translucent tape.

9. The method of claim 7 wherein said translucent tape is a synthetic resin.

10. The method of claim 8 wherein said translucent tape is a synthetic resin.

11. The method of claim 9 wherein said synthetic resin is a polyester.

12. The method of claim 10 wherein said synthetic resin is a polyester.

13. The method of claim 11 wherein said polyester is poly (ethylene terephthalate).

14. The method of claim 12 wherein said polyester is poly (ethylene terephthalate).

15. The method of claim 9 wherein said synthetic resin is selected from the group consisting of polyethylene and polypropylene.

16. The method of claim 10 wherein said synthetic resin is selected from the group consisting of polyethylene and polypropylene.
